(19) United States
(12) Patent Application Publication
(10) Pub. No.: US 2010/0325137 A1
(43) Pub. Date: Dec. 23, 2010

(54) Method and system for musical multimedia content classification, creation and combination of musical multimedia play lists based on user contextual preferences

(76) Inventor: Yuri Luis Paez, Zapopan (MX)

Correspondence Address: Yuri Paez, Lince Oriente 217, Ciudad Bugambilias, Zapopan, Jalisco, 45237, M

(21) Appl. No.: 12/490,300

(22) Filed: Jun. 23, 2009

(51) Int. Cl. G06F 17/30; G06Q 30/00; G06Q 50/00; G06F 17/00

(52) U.S. Cl. 707/759; 705/26; 700/94; 707/769; 707/705; 707/802

(57) ABSTRACT

A method for creating, sharing, combining, and analyzing musical multimedia play lists based on a user contextual classification. Musical multimedia is media that utilizes a combination of different content forms such as music songs, movies, pictures, and sounds. This contextual classification is defined by relationships among key elements of the multimedia content. For example, the relationships for music songs are defined among musical genre, singer/player, or a specific music song with an activity list, places or locations, and states of feeling (i.e., mood or temper) defined by the user when he usually listens to music frequently.

### BRIEF DESCRIPTION OF THE DRAWINGS

FIG. 1: Proposed Music Classification Interface

FIG. 2: Proposed entity relation diagram to make persistent the information obtained from user's music libraries, rating preferences and musical preferred listening contexts

FIG. 3: Formula for calculate the compatibility musical index between two users

FIG. 4: Sample list of musical listening contexts identified by a unique ID

FIG. 5: Proposed detailed entity relation diagram to make persistent the user rating preferences and music preferred listening contexts for specific musical content such as music songs

FIG. 6: Proposed class definition for a web service implementation of music classification services

### TECHNICAL FIELD

This invention is related to information networks, and more particularly to employ social networks, web services, or storage systems to publish and share music classification and preferences based on inputs from multiple users.

### BACKGROUND OF THE INVENTION

Currently, most of the multimedia players have limited features to create multimedia musical play lists. The common procedure is based on user actions where he selects the corresponding multimedia content (one or more music items) and then, it is added to the play list. Similarly, other procedure to add multimedia musical content is by selecting information from the multimedia content such as album, artist, player, musical genre, and then, adding the items to the play list.

However, a common user usually wants to select a sub set of the play list depending on different environmental factors such as user mood, user activity, etc. The combination of environmental factors for a user is named as user context. For example, a user working on a difficult activity may require some specific kind of music allowing the concentration and focus; other user context may be a romantic dinner, where the user looks for music for the specific moment. In addition, users have preferred music, singers or players, albums, and genre but the specific moment where the user wants to listen to such music can not simply described with such information. This invention allows the classification of multimedia content based on additional preferences and contexts defined by the user. In the case of musical multimedia content such as songs, this invention allows the user to classify music genres, singers, players, albums, and songs according to a preference classification and relate them with a set of user contexts where he wants to listen to the music. This classification allows the combination of play lists from different users based on their preferences and contexts. The results from this combination will generate a play list where multiple users feel comfortable with respect to the music they are listening. For example, consider a group of friends gathered in a party and all of them belong to an internet-based social network where they share their music preferences and contexts. This invention will allow the selection of music for playing based on the combination of preferences and contexts; this selection will create a more conformable environment for the party. A second example will be the scenario where two people are traveling by car and they want to listen to music during the trip; this invention will combine the preferences and contexts from both users to generate the best selection for the trip based on their current common mood and environment (i.e., traveling).

### SUMMARY OF THE INVENTION

The goal for this invention is to allow the classification of musical multimedia contents based on the user cataloging (genre, singer, player, and album) and one or more user contexts. In addition, this invention allows the combination of multimedia play lists from different users into a single play list by selecting a common context from two or more user classifications. The contexts can be defined in terms of activity performed, location, and mood. Consider scenarios where multiple users attend the same location and they may want to listen to music according the location and their mood, such as the office, the gym, or a date.

### DETAILED DESCRIPTION OF THE INVENTION

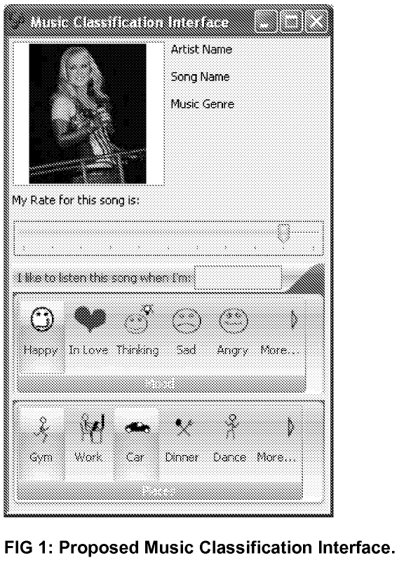

FIG. 1 shows a graphical user interface for classifying the preference and the corresponding contexts for a musical multimedia playable content.

This interface helps to understand how the method described in claim 1 where the users is capable of assigning a preference to a musical genre, player or singer, album, or specific song and then, relate them with one or more user listening contexts. The relationship among genre, album, singer, and song is arranged hierarchically as it was enlisted. This hierarchical relationship allows the inheritance of preferences and context relationships from one genre to all artists associated to such genre, and from all artists to all songs they perform. It is clear that some exceptions may occur but this generic approach will allow to perform a simple and easy classification. This hierarchical approach combined with the graphical user interface shown in FIG. 1 provides an easy and quick way to classify each song.

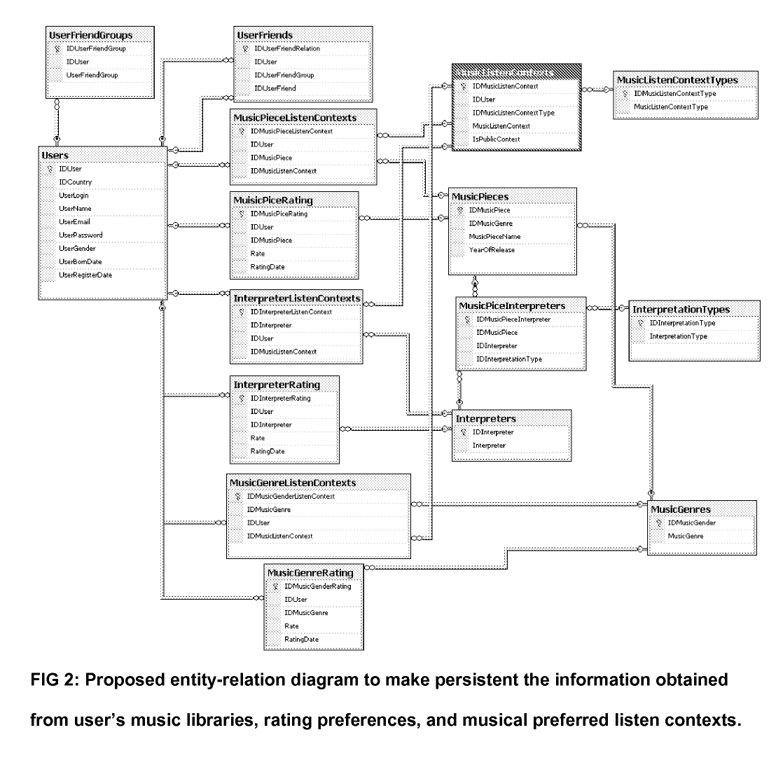

FIG. 2 shows an entity-relationship diagram used to storage the information persistently about music multimedia content, contexts, user preferences, and their corresponding classification among content, context, and preferences.

Each table is described as follows:

InterpretationTypes: This table corresponds to the type of participation within the multimedia musical content. For example, considering a musical song, types include main voice, chores, director, etc.

InterpreterListenContexts: This table contains the information representing the associations of singer/player and user contexts.

InterpreterRating: This table contains the information about the preference classification that one user defies for a specific singer or player.

Interpreters: This table contains the information about the singers, players, or groups representing the interpreter of the musical content.

MusicPiceRating: This table contains the information about the user preference grading to specific music multimedia items such as songs.

MusicGenreListenContexts: This table contains the information representing the associations of musical genres and user contexts.

MusicGenreRating: This table contains the information about the grade of preference defined by a user to specific musical genres.

MusicGenres: This table contains a description of musical genres.

MusicListenContexts: This table contains information about the user contexts where users usually listen to music (activities, places, moods, etc.)

MusicListenContextTypes: This table contains the context types which users usually listen to music.

MusicPiceInterpreters: This table associates a music song with one or more players (singers).

MusicPieceListenContexts: This table contains information about the relationship between musical songs and the user contexts.

MusicPieces: This table contains the information about the musical multimedia items such as songs.

UserFriendGroups: This table contains the information about groups of users. These groups are created to facilitate the managing of users.

UserFriends: This table contains information about the relationship between users. These relationships are used to allow the sharing and combination of musical classifications.

Users: This table contains information about the users.

The next SQL statement shows how a user musical play list can be generated using the persistent information scheme (entity-relationship diagram) shown in FIG. 2:

| | |
|---|---|
| SELECT | MusicPieces.IDMusicPiece, |
| | MusicGenres.MusicGenre, |
| | Interpreters.Interpreter, |
| | MusicPieces.MusicPieceName, |
| | MusicPieceListenContexts.IDUser, |
| | MusicPieceListenContexts.IDMusicListenContext, |
| | MusicPiceInterpreters.IDInterpretationType |
| FROM | MusicGenres RIGHT OUTER JOIN |
| | MusicPieces ON |
| | MusicGenres.IDMusicGenre = MusicPieces.IDMusicGenre |
| | LEFT OUTER JOIN |
| | Interpreters |
| | RIGHT OUTER JOIN |
| | MusicPiceInterpreters ON |
| | Interpreters.IDInterpreter = |
| | MusicPiceInterpreters.IDInterpreter ON |
| | MusicPieces.IDMusicPiece = |
| | MusicPiceInterpreters.IDMusicPiece |
| | LEFT OUTER JOIN |
| | MusicPieceListenContexts ON |
| | MusicPieces.IDMusicPiece = |
| | MusicPieceListenContexts.IDMusicPiece |
| | LEFT OUTER JOIN |
| | MuisicPiceRating ON |
| | MusicPieces.IDMusicPiece = |
| | MuisicPiceRating.IDMusicPiece |
| WHERE | (MusicPieceListenContexts.IDUser = @IDOfUser) AND |
| | (MusicPieceListenContexts.IDMusicListenContext = |
| | @IDOfTheMusicListenSelectedContext) AND |
| | (MusicPiceInterpreters.IDInterpretationType = |
| | @IDOfMainInterpreterType) |
| ORDER BY | MusicGenres.MusicGenre, |
| | Interpreters.Interpreter, MusicPieces.MusicPieceName |

In this SQL statement uses three parameters:

@IDOfUser: Unique identifier associated to the specific user who created the classification.

@IDOfTheMusicListenSelectedContext: This parameters represents the unique context identifier selected by the user to filter all of his contexts.

@IDOfMainInterpreterType: Unique identifier of the main player or singer in the song. This parameter is used to help the query to avoid duplicated results.

The next SQL statement illustrates how a combined musical play list containing only the matches from the information from two users based on the same context. This query is based on using the scheme shown in FIG. 2:

| | |
|---|---|
| SELECT | MusicPieces.IDMusicPiece, |
| | MusicGenres.MusicGenre, |
| | Interpreters.Interpreter, |
| | MusicPieces.MusicPieceName, |
| | MusicPieceListenContexts.IDUser, |
| | MusicPieceListenContexts.IDMusicListenContext, |
| | MusicPiceInterpreters.IDInterpretationType |
| FROM | MusicGenres |
| | RIGHT OUTER JOIN |
| | MusicPieces ON |
| | MusicGenres.IDMusicGenre = MusicPieces.IDMusicGenre |
| | LEFT OUTER JOIN |
| | Interpreters |
| | RIGHT OUTER JOIN |
| | MusicPiceInterpreters ON |
| | Interpreters.IDInterpreter = |
| | MusicPiceInterpreters.IDInterpreter ON |
| | MusicPieces.IDMusicPiece = |
| | MusicPiceInterpreters.IDMusicPiece |
| | LEFT OUTER JOIN |
| | MusicPieceListenContexts ON |
| | MusicPieces.IDMusicPiece = |
| | MusicPieceListenContexts.IDMusicPiece |
| | LEFT OUTER JOIN |
| | MuisicPiceRating ON |
| | MusicPieces.IDMusicPiece = MuisicPiceRating.IDMusicPiece |
| WHERE | (MusicPieceListenContexts.IDUser = @IDOfUser01) AND |
| | (MusicPieceListenContexts.IDMusicListenContext = |
| | @IDOfTheMusicListenSelectedContext) AND |
| | (MusicPiceInterpreters.IDInterpretationType = |
| | @IDOfMainInterpreter) AND (MusicPieces.IDMusicPiece IN |

| | |
|---|---|
| (SELECT | MusicPieces_1.IDMusicPiece |
| FROM | MusicPieces AS MusicPieces_1 |
| | LEFT OUTER JOIN |
| | MusicPieceListenContexts AS |
| | MusicPieceListenContexts_1 ON |
| | MusicPieces_1.IDMusicPiece = |
| | MusicPieceListenContexts_1.IDMusicPiece |
| WHERE | (MusicPieceListenContexts_1.IDUser = |
| | @IDOfUser02) AND |
| | (MusicPieceListenContexts_1.- |
| | IDMusicListenContext = |
| | @IDOfTheMusicListenSelectedContext))) |

ORDER BY MusicGenres.MusicGenre, Interpreters.Interpreter,
MusicPieces. MusicPieceName

This SQL statement uses four parameters:

@IDOfUser01: Unique user identifier for first user.

@IDOfUser02: Unique user identifier for second user.

@IDOfTheMusicListenSelectedContext: This parameter corresponds to the unique context identifier which is used to obtain the correspondences between two users.

@IDOfMainInterpreterType: Unique identifier of the main player or singer in the song. This parameter is used to help the query to avoid duplicated results.

The next SQL statement illustrates how to obtain a music play list as result from combining and joining the classifications from two users give an specific common context. This query is based on using the scheme shown in FIG. 2:

| | |
|---|---|
| SELECT | MusicPieces.IDMusicPiece, |
| | MusicGenres.MusicGenre, |
| | Interpreters.Interpreter, |
| | MusicPieces.MusicPieceName, |
| | MusicPieceListenContexts.IDUser, |
| | MusicPieceListenContexts.IDMusicListenContext, |
| | MusicPiceInterpreters.IDInterpretationType |
| FROM | MusicGenres RIGHT OUTER JOIN |
| | MusicPieces ON |
| | MusicGenres.IDMusicGenre = MusicPieces.IDMusicGenre |
| | LEFT OUTER JOIN |
| | Interpreters |
| | RIGHT OUTER JOIN |
| | MusicPiceInterpreters ON |
| | Interpreters.IDInterpreter = |
| | MusicPiceInterpreters.IDInterpreter ON |
| | MusicPieces.IDMusicPiece = |
| | MusicPiceInterpreters.IDMusicPiece |
| | LEFT OUTER JOIN |
| | MusicPieceListenContexts ON |
| | MusicPieces.IDMusicPiece = |
| | MusicPieceListenContexts.IDMusicPiece |
| | LEFT OUTER JOIN |
| | MuisicPiceRating ON |
| | MusicPieces.IDMusicPiece = MuisicPiceRating.IDMusicPiece |
| WHERE | (MusicPieceListenContexts.IDUser IN (@IDOfUse01, |
| | @IDOfUser02) AND |
| | (MusicPieceListenContexts.IDMusicListenContext = |
| | @IDOfTheMusicListenSelectedContext) AND |
| | (MusicPiceInterpreters.IDInterpretationType = |
| | @IDOfMainInterpreterType) |
| ORDER | MusicGenres.MusicGenre, |
| BY | Interpreters.Interpreter, MusicPieces.MusicPieceName |

This sentence contains four parameters:

This SQL statement uses four parameters:

@IDOfUser01: Unique user identifier for first user.

@IDOfUser02: Unique user identifier for second user.

@IDOfTheMusicListenSelectedContext: This parameter corresponds to the unique context identifier which is used to obtain the correspondences between two users.

@IDOfMainInterpreterType: Unique identifier of the main player or singer in the song. This parameter is used to help the query to avoid duplicated results.

This invention includes a hierarchical approach to handle the musical classifications from the users. This approach allows to have always a classification even when the users only has the common classification such as genre, album, singer, etc. In other words, the default classification scheme is based on the common scheme where users classifies music by genre, player or signer, and album.

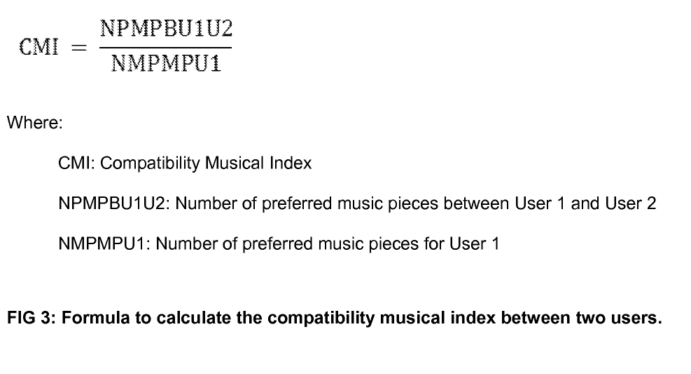

FIG. 3 show the formula to calculate the musical compatibility index. The goal of this index is to reduce the complexity to a single numerical indicator representing the match music preferences between two users. This index is calculated as the ratio between the number of music songs having a high preference between user 1 and two, and the total number of music songs from user 1 having a high preference. The music matching compatibility between user 1 and 2 is calculated using this formula.

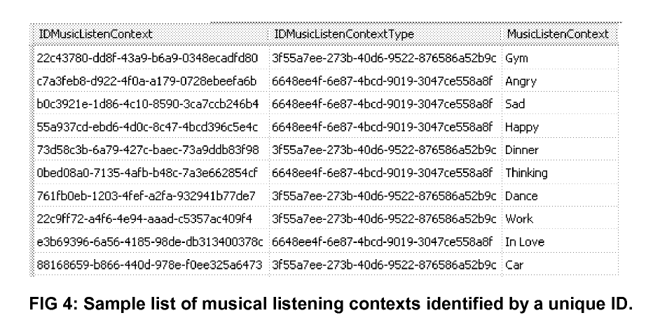

FIG. 4 shows an example of a predefined context list based on activities and moods where users listen to music. Although this list may be too big, it is important to have a reasonable small list to allow the compatibility analysis among users. Another alternative is to allow users to create their own context lists and then, they can share this classification with other people using social networks or web services. The music content classified within personalized context can only be combined with users who used the same classification contexts. This list of context can be used efficiently only if each context has an unique identifier for being related with players, singers, albums, and music songs.

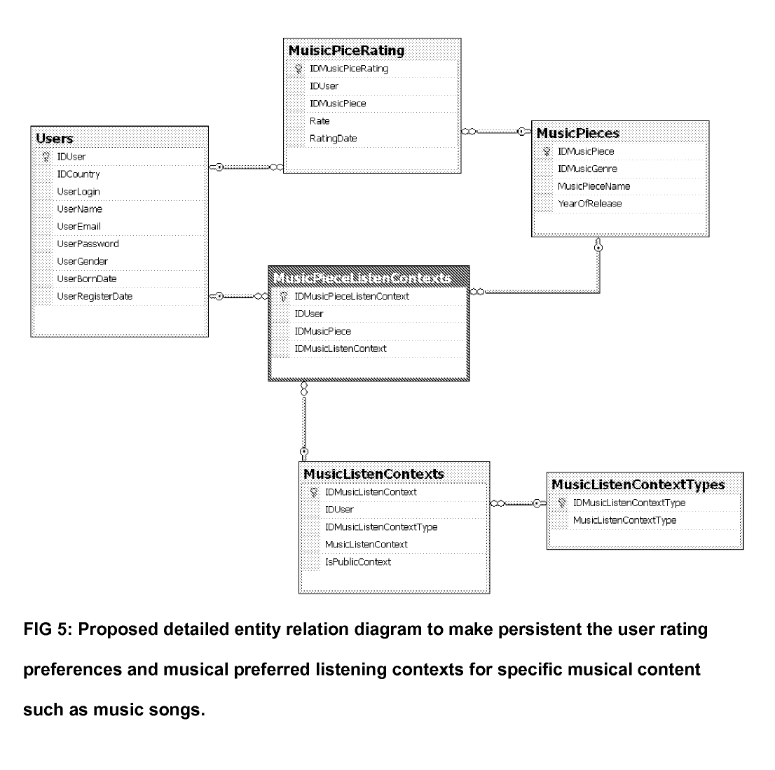

FIG. 5 shows an entity-relationship diagram used to accomplish the persistency for the classification id associated to a specific music song for an specific user. This unique id relates the user who created the classification, the music song, the preference classification, and the relationships with the specific contexts. These relationships will allow the identification of how a music song has been classified by every user or to obtain the preference play list from an specific user from an specific context.

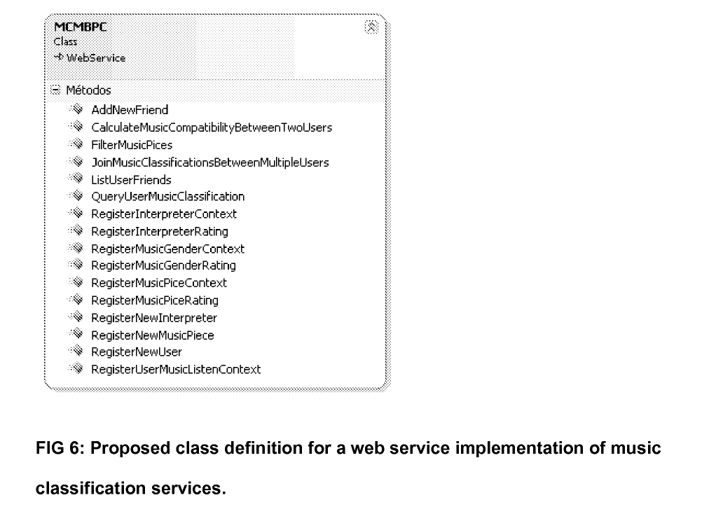

FIG. 6 shows the definition of a class which can be implemented as a web service to offer:
Add a new user, such a friend, for sharing and combining musical classifications.
Calculate the compatibility match index between two users.
Retrieve the playlist filtered using different criteria such as contexts, musical genres, etc.
Retrieve the list of friends from a specific user.
Associate contexts with play lists or singer, player, genre, or albums.
Retrieve classifications from other users
Assign a preference level for an specific interpreter
Assign a preference level for specific genre
Assign context where the user wants to listen to specific music or songs
Register a new interpreter, song, user, or player
Register a personalized context for an user

This list shows some services that can be implemented using this invention.

What is claimed is:

1) A method for classifying musical multimedia content based on user preferences. These preferences are assigned to musical genre, a singer/player, a set of one or more music album, a list of musical songs, or a single musical song or play, and the corresponding relationship where the user wants to listen to such music.

2) The method of claim 1, wherein the method is used to create musical play lists by selection or identifying a specific context for the user.

3) The method of claim 1, wherein the method is used to combine musical play lists from two or more users allowing the generation of new play lists corresponding to the union or interjection of play lists given specific user contexts.

4) A method to compute a compatibility music index or a musical match index between two users having stated their preferences.

5) The usage of a list of predefined and configurable user contexts which the user can use to classify music according to the method of claim 1 and 2.

6) The usage of a unique identifier which relates the classification of a music song with the user who established such classification according to the method of claim 1 and 2.

7) The publication of web services based on the method of claim 1 and 2 allowing:
distributed storage of the musical user classification, sharing of user classification with other users, query of user classifications, and combination of play lists from two or more users.

8) The method of claim 1, wherein the method is implemented as a software product.

9) The method of claim 1, 2, 3, or 4 as part of web sites.

10) The method of claim 1, 2, 3, or 4 as part of music players.

11) The method of claim 1, 2, 3, or 4 as part of social networks.

12) The method of claim 1, 2, 3 or 4 as part of internet-based music stores.
